(19) United States
(12) Patent Application Publication
(10) Pub. No.: US 2009/0126821 A1
(43) Pub. Date: May 21, 2009

(54) HIGH-PRESSURE RUBBER HOSE AND METHOD AND APPARATUS FOR PRODUCING THE SAME

(75) Inventors: Imre Domonkos, Szeged (HU); Tamas Katona, Algyo (HU); Jozsef Kiraly, Toszeg (HU); Laszlo Nacsa, Budapest (HU); Tibor Nagy, Budapest (HU)

Correspondence Address: DUANE MORRIS LLP - Princeton, PO BOX 5203, PRINCETON, NJ, 08543-5203, US

(73) Assignee: ContiTech Rubber Industrial Gumiipari Kft., Szeged (HU)

(21) Appl. No.: 12/251,832

(22) Filed: Oct. 15, 2008

(30) Foreign Application Priority Data
Oct. 15, 2007 (HU) P 0700674

(51) Int. Cl. F16L 11/08; B29C 63/06

(52) U.S. Cl. 138/127; 138/137; 138/133; 156/188; 156/475; 428/36.91

(57) ABSTRACT

The object of the invention is a high-pressure rubber hose comprising a liner (1), rubberized textile layers (2), main reinforcing plies (3) and a cover (5).

The invention is essentially characterised by that the hose has an integrated coupling (7) and a permanent two- or three-dimensionally curved shape, which shape it retains in the absence of external force.

The method according to the invention comprises the steps of building the high-pressure hose from its structural elements on a mandrel, providing an integrated coupling (7) to the hose, securing the coupling to the hose, removing the built-up hose structure from the mandrel, producing the desired final shape of the hose before vulcanization, and retaining the final shape by keeping the hose fixed during vulcanization.

The apparatus according to the invention is essentially characterised by that it comprises blinds (12) matching the hose couplings (7), the blinds being disposed with fixed orientation and position.

The invention concerns a fibre-reinforced, vulcanized high-pressure rubber hose, and a method and apparatus for producing the same.

In the usage of the present specification the term “high pressure hose” designates hoses with a design working pressure greater than 1.5 MPa.

Such hoses are often referred to as flexible pipe in literature. The flexibility of high-pressure hoses is, however, fairly restricted, as their minimum bend radius is usually larger than 10× the inner diameter. In equipment used in the oil industry the minimum bend radius of high-pressure hoses is therefore often a limiting factor with respect to the geometrical configuration of the apparatus.

Fibre-reinforced high-pressure rubber hoses are disclosed in several patent specifications, for instance HU 168 837 (corresponding patents are GB 1,470,823 and U.S. Pat. No. 4,000,920), and HU 198 781 (corresponding documents are GB 2,205,625; GB 8,800,516D, and U.S. Pat. No. 4,860,798), as well as U.S. Pat. No. 6,938,932. These hoses are manufactured and vulcanized on a rigid straight mandrel. Known art products commonly comprise a rubber liner, rubberized textile layers for distributing mechanical load, helically wound main reinforcing plies made from steel cable or steel wire, embedding rubber layers disposed between the steel reinforcing plies, and a rubber cover.

To provide increased stress resistance such hoses are usually fitted with integrated couplings, with the hose body and the metal coupling being connected usually by adhesive-filling resin. It should be noted here that in the present specification the term “integrated coupling” refers to couplings that are fitted to the hose body before hose vulcanization.

It is also known that the automotive industry makes wide use of low-pressure hoses vulcanized to a curved shape. These hoses include circular knitted reinforcing plies. The permanent shape of the hose is produced by pulling the uncured hose on a mandrel bent to the desired shape, and vulcanizing it in a steam boiler. After the vulcanization process has ended, the hose is pulled off from the mandrel.

Although, as it has already been mentioned and will be touched upon below, forming curved or bent hose sections would be advantageous for the application of high-pressure hoses, for a number of reasons the above described method cannot be applied for high-pressure hoses, especially for hoses with integrated couplings. First, as it is apparent for those skilled in the art, for high-pressure hoses steel reinforcements should be applied as main reinforcing plies. Characteristics of hoses having such reinforcing plies are obviously very different from hoses with circular knitted plies as the former cannot be bent easily and their minimum bend radius is fairly large. A further limitation is that the integrated couplings of high-pressure hoses are made from rigid metal, which would prevent the hose from getting pulled off a curved mandrel in case the conventional manufacturing method (vulcanization on mandrel) was applied.

For these reasons, fibre-reinforced high pressure rubber hoses having integrated couplings have been invariably manufactured at a straight state. However, for actual use such hoses are almost always built in bent to various curved shapes resembling the letters U, J, or L. The resulting stress in the hose material reduces service life. Cracks may also appear on the hose surface due to the combined effect of ozone and stress. Water entering the hose through the cracks causes corrosion of the reinforcing plies, and finally may lead to the breaking of the hose or might even cause an accident.

The objective of the invention is therefore to eliminate drawbacks present in prior art and satisfy an existing demand by providing a novel solution.

The invention was driven by the recognition that our objective can be achieved only in case the final shape of the hose is produced by bending the uncured hose after it has been built from its structural elements (including the integrated coupling) but before it undergoes vulcanization. To create the novel high-pressure rubber hose it was necessary to provide an apparatus and method for putting into practice the recognition related to the hose products the present invention concerns.

The principal novel features of the high-pressure rubber hose according to the invention are that the high-pressure vulcanized hose comprises an integrated coupling, and the hose body itself has a permanent bent/curved shape that the hose retains in the absence of external force. Prior to our invention no known art solution for producing high-pressure hoses included both of these two features.

The high-pressure rubber hose according to the invention therefore comprises a liner, rubberized textile layers, main reinforcing plies, and a cover, and is characterised by having an integrated coupling and by having a permanent two- or three-dimensionally curved shape, which shape it retains in the absence of external force.

According to a preferred embodiment of the invention the main reinforcing plies are implemented as at least two layers of helically wound steel cable, the two layers being wound in opposite senses.

In another preferred embodiment the main reinforcing plies are implemented as at least two layers of helically wound solid steel wire, the two layers being wound in opposite senses.

The preferred embodiments already mentioned may include an additional helical reinforcement that is wound at an angle of less than 10°.

In specific cases the rubber hose according to the invention comprises a flexible internal stripwound pipe.

The rubber hose according to the invention comprises a liner made from natural or synthetic rubber, from thermoplastic polymer, or from thermoplastic elastomer.

As it has already been mentioned, a further object of the invention is a method for producing the above described hose.

The method according to the invention essentially comprises the steps of building the high-pressure hose from its structural elements on a straight mandrel, providing an integrated coupling to the hose, securing the coupling to the hose, removing the hose from the mandrel, producing and fixing the desired final shape of the hose before vulcanization, and retaining the final shape by keeping the hose fixed during vulcanization.

The apparatus for carrying out the method according to the invention is characterised by that it comprises blinds matching the hose couplings, the blinds being disposed with fixed orientation at fixed position. According to a preferred embodiment, in addition to the blinds, the apparatus has one or more support stands, and/or fixing elements, with the support stands and fixing elements being applied for keeping the hose body in a fixed position.

In a further preferred embodiment the apparatus comprises a mounting plate having a plurality of hole rows, with the blinds flanges being releasably secured to the mounting plate, and with the optionally included support stand or support stands and/or fixing elements being also releasably secured to the mounting plate.

With the application of the solution according to the invention the above listed drawbacks are substantially eliminated because the rubber hose according to the invention is free of stress in its bent state, and the outer cover of the hose has a greater resistance to ozone and harsh weather compared to hoses bent to shape after vulcanization on a straight mandrel. A further advantage of the hose according to the invention is that hoses vulcanized after producing their final shape (shape-cured hoses) may be bent to a smaller bend radius than hoses vulcanized in a straight state in a conventional fashion.

Details of the invention will now be explained with reference to the included examples and attached drawings, where

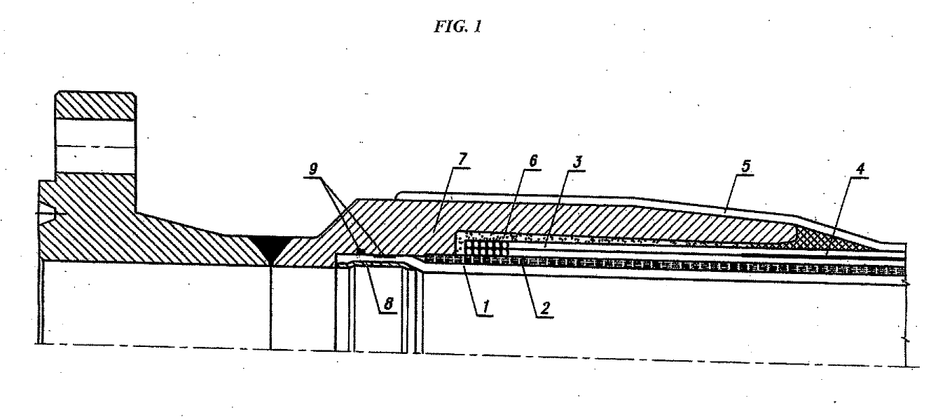

FIG. 1 shows a conceivable embodiment of the hose and hose coupling without an internal stripwound pipe (a so called smooth-bore hose),

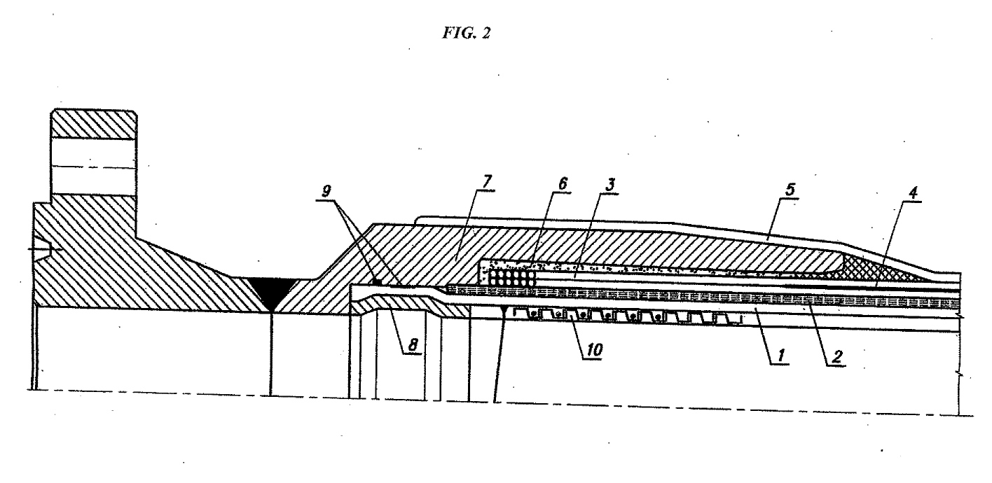

FIG. 2 illustrates an embodiment comprising an internal stripwound pipe,

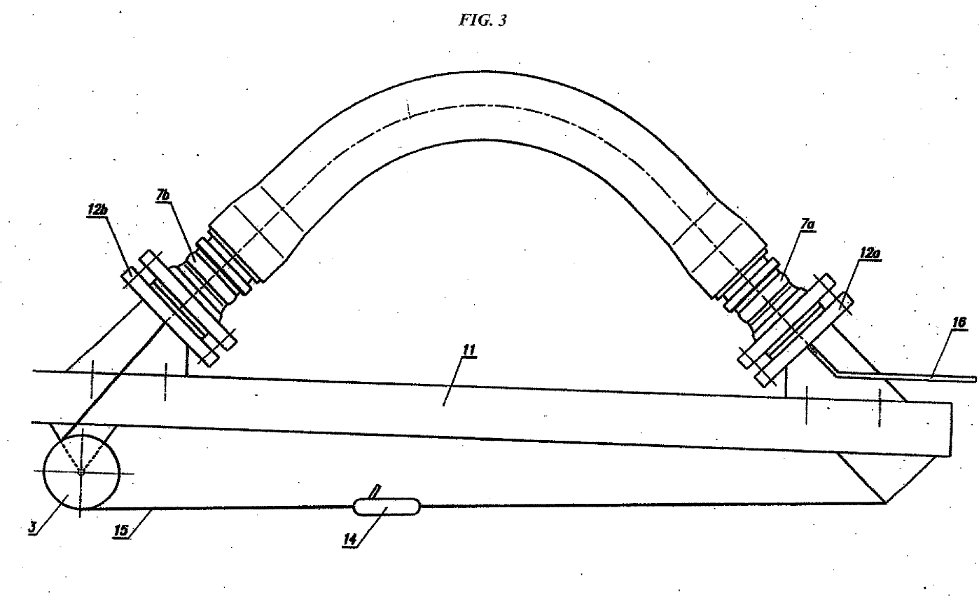

FIG. 3 shows the bent hose ready for vulcanization, together with the fixing frame applied for carrying out the production method, according to the invention and

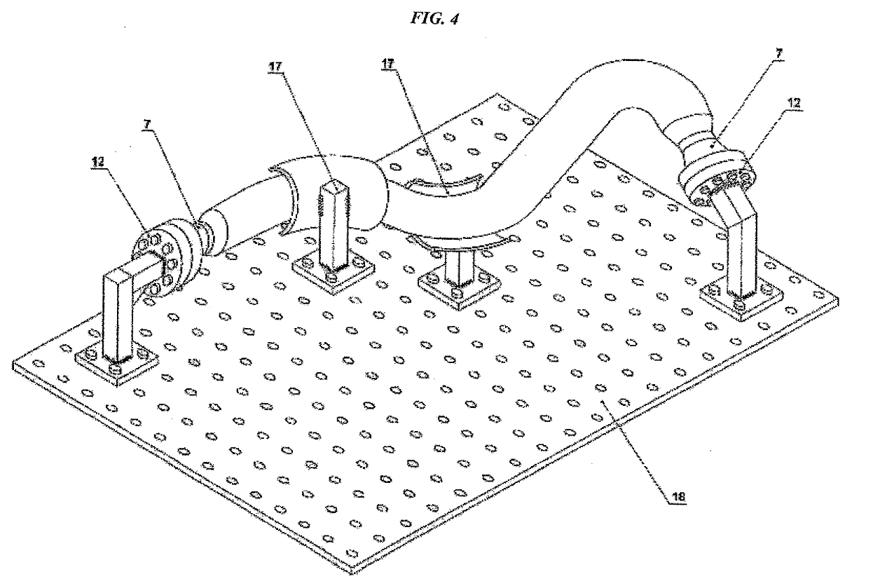

FIG. 4 illustrates another possible embodiment of the apparatus applied for retaining the hose shape during vulcanization.

As it is shown in the drawings, the hose according to the invention comprises a gas-tight and fluid-tight layer, the liner 1. The liner 1 is made either of natural rubber, synthetic rubber, thermoplastic elastomer, or a plastic of sufficient elasticity, such as polyamide, poly(vinylidene fluoride), or a copolymer containing vinylidene fluoride and/or tetrafluorethylene. In the embodiments shown in FIGS. 1 and 2 rubberized textile layers 2 are included above the liner 1. These layers are, however, included optionally in the high pressure rubber hose according to the invention and may be absent in case of other embodiments. The main reinforcing plies 3 are implemented as high-strength filaments, steel cables, or polymer based filaments that are helically wound in at least two layers wound in opposite senses. The space between the filaments making up the reinforcing plies is filled with an embedding rubber layer 4. Preferably the embedding rubber layer 4 strongly adheres to the main reinforcing plies 3 in the finished product (that is, after vulcanization). The coupling 7 is firmly attached to the main reinforcing plies 3 and is connected to the liner 1 in a gas-tight and liquid-tight manner. Finally, the hose has a cover 5.

In specific cases the hose may comprise a flexible internal stripwound pipe 10 such as in the embodiment shown in FIG. 2. This flexible internal stripwound pipe 10 is usually made of stainless steel. The internal stripwound pipe 10 prevents the hose liner 1 from blistering in case of rapid decompression and also prevents hose body kinking when the hose is bent. In specific cases the hose may comprise a rigid helical reinforcement made e.g. from steel or fibreglass reinforced plastic, laid with low pitch, at a lay angle of less than 10°. (Lay angle is measured against a circular cross section taken perpendicularly to the hose axis)

The smooth-bore hose illustrated in FIG. 1 is manufactured by first putting the liner 1 of the hose on a straight mandrel treated with mould release agent. The liner 1 is put on the mandrel in a manner known per se, such as by winding an uncured rubber sheet on a rotating mandrel, by pulling an extruded rubber or plastic pipe onto the mandrel, or by extruding the liner 1 directly on the mandrel. Next, the inner sleeve 8 (applied for protecting the sealing area of the hose) is inserted under the end portion of the liner 1.

In specific cases, a plurality of rubberized textile layers 2 may be applied onto the liner 1, the rubberized textile layers 2 being wound on the liner 1 in alternating senses. In case the liner 1 is manufactured from rubber, the liner 1 and the rubberized textile layers 2 are preferably prevulcanized to provide liquid-tight sealing in this early stage and also to ensure that the unfinished hose (containing non-vulcanized rubber layers) can be removed intact from the mandrel. In the next step the main reinforcing plies 3 and the embedding rubber layer 4 are added by helically winding them in alternating senses at an angle and with a filament number determined by the hose design.

The couplings 7 are then connected to the hose, and previously disposed sealing elements 9 and/or uncured rubber are applied to produce the sealing between the liner 1 and the couplings 7. The couplings 7 are secured to the hose body utilising adhesive-filling resin 6. The resin is cross-linked either at room temperature or by heating the coupling. In the latter case the rubber material in the sealing space may also be vulcanized, without vulcanizing the rubber layer between the main reinforcing plies. Next, the rubber cover 5 is added while continuously rotating the mandrel, and the hose is wrapped with a polyamide textile tape. In the next step the partially vulcanized or uncured hose is pulled off from the mandrel and secured into the fixing frame 11. One end of the hose is connected to a blind matching the coupling, e.g. a blind flange 12, the other end being bent to the desired shape applying a double pulley 13, a rope 15, and rope tensioning device 14. Next the coupling 7 is attached to the blind 12. Optionally a flexible conduit 16 is applied to pressurize the interior of the hose in case pressurizing is necessary. Finally, the hose undergoes vulcanization while retained in the fixing frame 11. Vulcanization may be carried out in a variety of ways known per se, such as in a large steam boiler, in an air boiler, applying a heating blanket, utilising electric resistance heating, etc.

The hose shown in FIG. 2 comprises a corrosion-resistant internal stripwound pipe 10. In this case the shape-cured hose according to the invention is manufactured similarly to the steps of the process described above with regard to the smooth bore hose, with the obvious difference that the suitably prepared stripwound pipe 10 should be pulled onto the mandrel before adding the liner 1. Another difference between the two processes may be that in case of including a stripwound pipe it is not necessary to pressurize the hose during vulcanization even when the liner 1 is made of rubber because the internal stripwound pipe provides sufficient mechanical support for the liner 1 and the layers located above it.

The apparatus for manufacturing the hoses according to the invention is illustrated in FIG. 3, showing a non-limiting exemplary embodiment.

FIG. 3 shows a simple variant of the apparatus, implemented as a fixing frame 11 comprising retaining elements that constrain both the position and orientation of both hose couplings. The retaining elements are preferably implemented as fixedly disposed blinds 12 matching the hose couplings. The position and orientation of the blinds 12 is established with respect to the desired curvature of the hose. In a preferred embodiment of the apparatus the fixing frame 11 has a double pulley 13 that, cooperating with a rope or steel cable 15 and rope tensioning device 14 is applied for easily bending the unfinished hose to obtain the desired position of the couplings and keep that position during the vulcanization process.

FIG. 4 illustrates another preferred embodiment of the apparatus according to the invention. This embodiment may be applied for producing hoses with three-dimensional bend. The apparatus is based on a mounting plate 18 to which the blinds 12 are attached at positions and directions corresponding to the desired bend of the hose. Support stands 17, applied for retaining the hose in its desired position during vulcanization, are also attached to the mounting plate 18. The mounting plate 18 expediently has a plurality of hole rows (the drawing shows such a variant) with the blinds 12 and the support stands 17 being releasably attached to the mounting plate 18 utilising screws or making use of other types of releasable joints. This embodiment may be advantageously applied for producing shape-cured hoses of different length and shape utilizing the same apparatus.

Further characteristics and advantages of the present invention will be readily apparent from the following non-limiting description of actual manufacturing examples.

### EXAMPLES

### Example 1

The manufacturing process of a smooth bore hose will be described. The hose coupling and the layers of the hose are shown in FIG. 1.

A liner 1 from oil resistant uncured rubber is extruded on a 3″ (76 mm) diameter mandrel treated with mould release agent. The thickness of the liner is 5 mm. Next, two rubberized textile layers 2 at a thickness of 1.5 mm each are wound in opposite senses on the liner 1 at an angle of 45°, and then an embedding rubber layer 4 is added at a thickness of 1 mm. The layers produced so far are wrapped in a polyamide textile wrapping tape and are prevulcanized in a steam boiler to provide the gas-tightness of the liner 1. After removing the polyamide ribbon the inner sleeves 8 are inserted under the end portions of the liner 1, and a further embedding rubber layer 4 is added at a thickness of 1 mm. The main reinforcing plies 3 are implemented as a steel cable with a diameter of 3.5 mm and 48 filaments per layer. Two main reinforcing plies 3 are added, the first at an angle of 37° and the second at an angle of 34°, with embedding rubber layers 4 being added at a thickness of 2 mm between the two main reinforcing plies 3 and above the second ply, except to those portions of the hose body that will be covered by the hose couplings 7, to be added in a subsequent step. In the next step the sealing space is filled with uncured rubber, the couplings 7 are connected and the adhesive-filling resin 6 is filled in the coupling. Then the resin is cross-linked by heating, while at the same time the sealing rubber layer gets vulcanized to the coupling 7 and to the rubber liner 1 in the zone where it touches the coupling 7. While continuously rotating the mandrel, the rubber cover 5 is wrapped from uncured rubber sheet. The thickness of the cover is 4 mm. The hose is tightly wrapped in a polyamide textile wrapping tape, that due to heat shrinking will compress the hose structure during vulcanization.

As according to the invention vulcanization is not carried out on the mandrel, the hose body is pulled off therefrom, and is secured to the fixing frame 11, with both ends of the hose being connected to the blinds 12 matching the hose couplings. Applying nitrogen gas through flexible conduit 16 the interior of the hose is pressurized to 5 bars and the hose is vulcanized at 145° C. in a steam boiler.

After the hose has cooled down, the polyamide wrapping tape is removed and the hose is depressurized.

### Example 2

An internal stripwound pipe 10 made of stainless steel was pulled on a 6″ (152 mm)-diameter mandrel. A liner 1 made from oil resistant uncured rubber sheet was added onto the internal stripwound pipe 10 at a thickness of 6 mm. Next, three rubberized textile layers 2 at a thickness of 1 mm each were wound in opposite senses on the liner 1 at an angle of 45°, and then an embedding rubber layer was added at a thickness of 4 mm. The layers produced thus far were wrapped in a polyamide ribbon and were prevulcanized in a steam boiler. After removing the polyamide ribbon a further embedding rubber layer 4 was added at a thickness of 1 mm. The main reinforcing plies 3 were implemented as steel cables with a diameter of 3.5 mm and 75 filaments per layer. Two main reinforcing plies 3 were added, the first at an angle of 36° and the second at an angle of 35°, with embedding rubber layers 4 being added at a thickness of 2 mm between the two main reinforcing plies 3 and above the second ply, except to those portions of the hose body that would be covered by the hose couplings 7, to be added in a subsequent step. In the next step the sealing space was filled with uncured rubber, the couplings 7 were connected and the adhesive-filling resin 6 was loaded. The resin was cross-linked by heating, while at the same time the sealing rubber layer got vulcanized to the coupling 7 and to the rubber liner 1 in the zone where it touched the coupling 7. While continuously rotating the mandrel, the rubber cover 5 made from uncured rubber sheet was added. The cover rubber was 6 mm thick. The hose was then tightly wrapped in a polyamide wrapping tape that due to heat shrinking would compress the hose structure during vulcanization.

Because according to the invention vulcanization is not carried out on the mandrel, the hose body was pulled off therefrom, and was secured to the fixing frame 11. The hose body was bent to a bend radius of 1.4 m at this point. After the hose cooled down, the polyamide wrapping tape was removed. The hose thus produced may be easily bent to a bend radius of 0.9 m, while the minimum bend radius of similar hoses is 1.6 m. A successful 8-hour pressure test was carried out at a pressure 1.5 times exceeding the working pressure of the hose, with the hose being bent to a bend radius of 0.9 m.

1. A high-pressure rubber hose comprising a liner (1), rubberized textile layers (2), main reinforcing plies (3) and a cover (5), wherein the hose has an integrated coupling (7) and the hose has a permanent two- or three-dimensionally curved shape, the shape the hose retains in the absence of external force.

2. The high-pressure rubber hose according to claim 1, wherein the main reinforcing plies (3) are implemented as at least two layers of helically wound steel cable, the two layers being wound in opposite senses.

3. The high-pressure rubber hose according to claim 1, wherein the main reinforcing plies are implemented as at least two layers of helically wound solid steel wire, the two layers being wound in opposite senses.

4. The high-pressure rubber hose according to claim 1, wherein the hose further comprises an additional helical reinforcement that is wound at an angle less than 10°.

5. The high-pressure rubber hose according to claim 1, wherein the hose further comprises a flexible internal stripwound pipe (10).

6. The high-pressure rubber hose according to claim 1, wherein the hose further comprises a liner (1) made from a natural rubber, a synthetic rubber, a thermoplastic polymer, or a thermoplastic elastomer.

7. A method for producing the high-pressure hose according to claim 1, comprising the steps of building up the high-pressure hose from its structural elements on a straight mandrel, providing an integrated coupling (7) to the hose, securing the coupling to the hose, removing the hose from the mandrel, producing and fixing the desired final shape of the hose before vulcanization, and retaining the final shape by keeping the hose fixed during vulcanization.

8. An apparatus for carrying out the method of according to claim 7, wherein the apparatus comprises blinds matching the hose couplings (7), the blinds being disposed with a fixed orientation at a fixed position.

9. The apparatus according to claim 8, wherein the apparatus has blinds (12), one or more support stands (17), and/or fixing elements, with the support stands and fixing elements being applied for keeping the hose body in a fixed position.

10. The apparatus according to claim 9, wherein the apparatus has a mounting plate (18) comprising a plurality of hole rows, the blinds (12) being releasably secured to the mounting plate (18), with the support stand (17) or support stands and/or fixing elements being also releasably secured to the mounting plate.
